(19) United States
(12) Patent Application Publication
(10) Pub. No.: US 2011/0224907 A1
(43) Pub. Date: Sep. 15, 2011

(54) MINERAL INSULATED CABLE FOR DOWNHOLE SENSORS

(75) Inventor: Gerald Chalifoux, Sherwood Park (CA)

(73) Assignee: PETROSPEC ENGINEERING LTD., Edmonton (CA)

(21) Appl. No.: 12/722,444

(22) Filed: Mar. 11, 2010

(51) Int. Cl. E21B 47/06; G01K 7/02

(52) U.S. Cl. 702/11; 374/179; 374/E07.004

(57) ABSTRACT

An apparatus for measuring downhole pressure includes a plurality of conductors within a mineral insulated cable, a pressure sensor attached to at least two of the conductors, and a thermocouple embedded in the mineral insulated cable. The pressure sensor generates a signal that is dependent upon pressure. The thermocouple is rated for temperatures greater than 150° C. The thermocouple generates a signal that is dependent upon temperature.

### FIELD

This relates to mineral insulated cables for measuring downhole temperature and pressure.

### BACKGROUND

Mineral insulated cables are commonly used for high temperature applications. In high-temperature applications, such as SAGD wells, the downhole temperature is commonly measured using a thermocouple.

### SUMMARY

There is provided an apparatus for measuring downhole temperature and pressure, comprising a mineral insulated cable containing a plurality of conductors. A pressure sensor is attached to at least two of the conductors, the pressure sensor generating a signal that is dependent upon pressure. The pressure sensor may generate a signal that is dependent upon temperature and pressure, and may be a piezometer. A thermocouple is embedded in the mineral insulated cable, comprises two of the plurality of conductors and generates a signal that is dependent upon temperature. There may be a processor connected to the conductors for calculating pressure based on the signal from the thermocouple and the signal from the pressure sensor.

There is provided a method of measuring downhole pressure, comprising the steps of: providing a mineral insulated cable as described above; using the signal from the thermocouple to determine the pressure from the signal from the piezometer; injecting the mineral insulated cable into a well; and measuring the temperature and pressure in the well. The pressure sensor may generate a signal based on pressure and temperature, the pressure sensor may be a piezometer, and the method may comprise the step of calculating the pressure based on the signal from the thermocouple and the signal from the pressure sensor.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic diagram of a mineral insulated cable installed downhole.

FIG. 2 is a perspective view in section of a mineral insulated cable.

FIG. 3 is a detailed side elevation view in section of a sensor end of a mineral insulated cable.

FIG. 4 through 6 are alternative schematic diagrams of a mineral insulated cable installed downhole.

### DETAILED DESCRIPTION

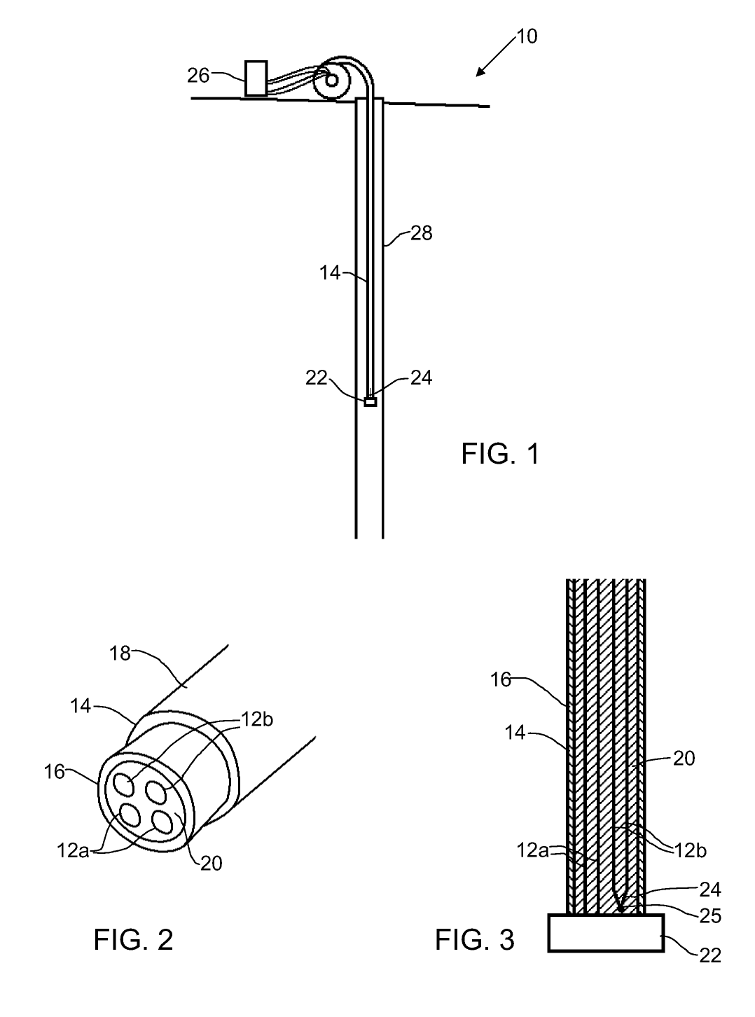

An apparatus for measuring downhole pressure generally identified by reference numeral 10, will now be described with reference to FIGS. 1 and 6.

### Structure and Relationship of Parts:

Referring to FIG. 2, apparatus 10 has a plurality of conductors within a mineral insulated cable 14. While two pairs of conductors 12a and 12b are shown, the number will depend on the number of components that are used down hole. The composition of mineral insulated cable 14 is well known in the industry, and preferably includes a metal sheath 18 may include additional sheathing 16, and has mineral insulation filling 20 that separates and insulates conductors 12a and 12b. Referring to FIG. 3, a pressure sensor 22 is attached to conductors 12a at the lower end of mineral insulated cable 14, as shown in FIG. 1. Pressure sensor 22 generates an electric signal that is dependent upon pressure. In a preferred embodiment, pressure sensor 22 is a piezometer, which generates a signal that is dependent upon both temperature and pressure. Normally, a piezometer is connected to four conductors—two for the vibrating wire, and two for the internal thermistor, as temperature readings are required to adjust the piezometer reading for temperature. However, as the internal thermistor is either not used or removed in apparatus 10, only two conductors are needed for piezometer 22.

Referring to FIG. 3, apparatus 10 also has a thermocouple 24 formed from conductors 12b, which are embedded in mineral insulated cable 14 and connected at point 25 adjacent to pressure sensor 22, as shown in FIG. 1. Thermocouple 24 is rated for temperatures greater than 150° C. The upper temperature limit of apparatus 10 will depend on the materials used, and may be as high as 1400° C. using materials known in the art. Thermocouple 24 is sufficiently close that the temperature of pressure sensor 22 can be determined within a relatively small margin of error. In one example, the margin of error was +/−2.2%. Thermocouple 24 is preferably a type-k thermocouple, which has a sufficient temperature rating to be used in high temperature applications. Thermocouple 24 generates a signal that is dependent upon temperature. There is shown a processor 26 connected to conductors 12 that receives the signals from thermocouple 24 and pressure sensor 22. When pressure sensor 22 is a piezometer, which generates a signal related to both temperature and pressure, the signal from thermocouple 24 can be used by processor 26 to determine the pressure based on the known temperature.

While only four conductors are shown (two copper conductors 12a connected to pressure sensor 22 and two conductors 12b forming thermocouple 12b) it will be understood that more conductors may also be included to connect to other sensors, such as a flow sensor, or if a particular pressure sensor 22 requires additional conductors.

### Operation:

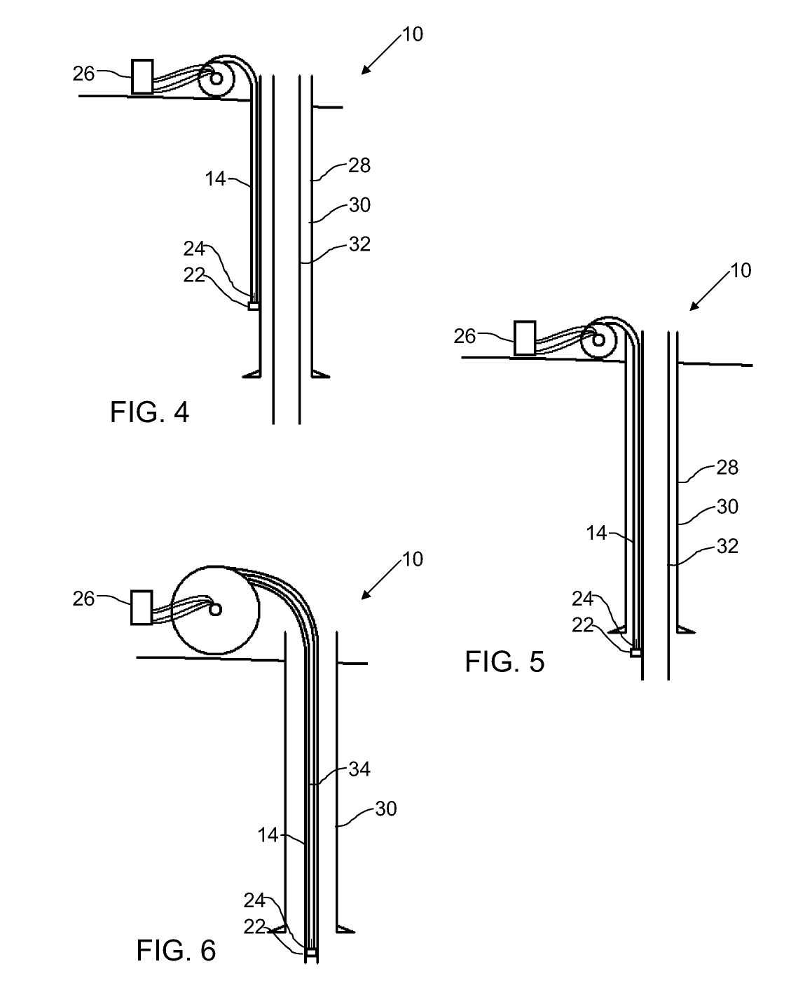

Referring to FIG. 1, apparatus 10 is prepared as described above with mineral insulated cable 14, pressure sensor 22 and thermocouple 24 and inserted downhole. The other end of mineral insulated cable 14 is connected to a processor for calculating the downhole pressure and temperature based on the signals received from thermocouple 24 and piezometer 22. As mineral insulated cable 14 is lowered into wellbore 28, the temperature and pressure are logged at the various depths. While FIG. 1 shows mineral insulated cable 14 being lowered by itself, it will more commonly be installed into well 28 by attaching it to the exterior of the well casing 30 as shown in FIG. 4, attached to the exterior of tubing 32 as shown in FIG. 5, or placed on the interior of coiled tubing 34 and lowering the coiled tubing into well 28 as shown in FIG. 6.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. An apparatus for measuring downhole temperature and pressure, comprising:
a mineral insulated cable containing a plurality of conductors;
a pressure sensor attached to at least two of the conductors, the pressure sensor generating a signal that is dependent upon pressure;
a thermocouple embedded in the mineral insulated cable, the thermocouple comprising two of the plurality of conductors and generating a signal that is dependent upon temperature.

2. The apparatus of claim 1, wherein the pressure sensor is generates a signal that is dependent upon temperature and pressure.

3. The apparatus of claim 2, further comprising a processor connected to the conductors for calculating pressure based on the signal from the thermocouple and the signal from the pressure sensor.

4. The apparatus of claim 2, wherein the pressure sensor is a piezometer.

5. A method of measuring downhole temperature and pressure, comprising the steps of:
providing a mineral insulated cable, comprising:
a plurality of conductors within a mineral-insulated cable;
a pressure sensor attached to at least two of the conductors, the pressure sensor generating a signal that is dependent upon pressure;
a thermocouple embedded in the mineral insulated cable, the thermocouple generating a signal that is dependent upon temperature;
injecting the mineral insulated cable into a well; and
measuring the temperature and pressure in the well.

6. The method of claim 5, wherein the pressure sensor is generates a signal that is dependent upon temperature and pressure.

7. The method of claim 6, further comprising the step of calculating pressure based on the signal from the thermocouple and the signal from the pressure sensor.

8. The method of claim 6, wherein the pressure sensor is a piezometer.
